(19) United States
(12) Patent Application Publication
(10) Pub. No.: US 2005/0226808 A1
(43) Pub. Date: Oct. 13, 2005

(54) Laser photo-catalytic process for the production of hydrogen

(75) Inventors: Mohammad Ashraf Gondal, Islamabad (PK); Abdul Hameed, Islamabad (PK); Zain Hassan Yamani, Dhabran (SA)

Correspondence Address: DENNISON, SCHULTZ, DOUGHERTY & MACDONALD, 1727 KING STREET, SUITE 105, ALEXANDRIA, VA, 22314, US

(73) Assignee: KING FAHD UNIVERSITY OF PETROLEUM AND MINERALS

(21) Appl. No.: 10/821,970

(22) Filed: Apr. 12, 2004

(51) Int. Cl. C01B 3/26

(52) U.S. Cl. 423/648.1

(57) ABSTRACT

A method for the photocatalytic conversion of an oxygenated hydrocarbon such as methanol includes the step of forming a colloidal suspension of a metal oxide catalyst in an oxygenated hydrocarbon. The method also includes the step of irradiating the colloidal suspension with pulsed laser irradiation in the range of about 180 nm to 520 nm wavelength at about 150 mJ per pulse at a temperature at about 16° C. to 60° C. for a period of about 30 minutes or more.

### FIELD OF THE INVENTION

The present invention relates to a photocatalytic process for the production of hydrogen and more particularly to a method for the conversion of an oxygenated hydrocarbon into hydrogen by forming a suspension of a metal oxide catalyst in an oxygenated hydrocarbon and irradiating the suspension with laser radiation having a wave length of between about 180 nm<λ<520 nm.

### BACKGROUND OF THE INVENTION

Due to an increasing demand for energy, for industrial use and other human activities, the reserves of fossil fuels are steadily diminishing. To fulfill the future energy requirements, new fuels are needed. In addition, the problem of environmental pollution and global warming has attracted the attention of the scientific community towards environmentally clean fuels such as hydrogen. Significant efforts have also been undertaken to identify acceptable substitutes for fossil fuels. The important criterion for a new fuel (energy source) is low cost, ample supply, renew-ability, safety, and pollution free.

There are three broad categories, which are presently being investigated to fulfill these needs: The categories are solar energy, nuclear power and chemical fuels. The current efforts in solar energy development are directed to the efficient conversion of the energy in sunlight to electricity. The conversion is typically accomplished through photovoltaic devices (semiconductors) that absorb and transform the wavelengths of light emitted by the sun. A unique advantage of using semiconductors to convert solar energy to electricity is the absence of pollution and minimum maintenance requirements. The main drawback in photovoltaic conversion of solar energy are the low efficiencies ˜10-15% and initial cost.

In nuclear power, energy is extracted from the natural decay of radioactive elements. Although large amounts of energy can be obtained from nuclear decay processes, the development of nuclear power plants has been limited because of the concerns over the handling of radioactive elements, the disposal of radioactive waste and public safety due to potential accidents during the operation of nuclear power plants. Chernobyl is one example of such a mishap.

Chemical fuels constitute another important class of energy sources and are now the subject of increased attention. This class of energy sources is based on the development of substances which are capable of providing energy through a chemical reaction. The search for new chemical fuels is focused on materials that combust cleanly and at less extreme conditions than gasoline and other petroleum based fuels. The objective of achieving clean burning fuels is directed at minimizing the environmentally undesirable by-products such as CO, CO₂ and NOₓ gases. In the past, much of the work on chemical fuels was focused on developing alternative chemical fuels for combustion engines. Various hydrocarbons and oxygenated hydrocarbon compounds such as methanol and ethanol have been considered. Although some promising results have been obtained, no alternative has proven sufficiently successful to motivate the costly transition from the current fuels to a new fuel source.

Hydrogen is considered to be as an ideal and clean fuel for power generation with virtually zero emissions of air pollutants and carbon dioxide. Many scientists consider hydrogen to be the best candidate for replacing conventional fossil fuels. They believe this because when reacted with oxygen, hydrogen produces only water as a by-product. Hence, hydrogen is an environmentally friendly fuel. It can also be used in fuel cells to power automobiles or to provide electricity and thermal energy. Hydrogen is also the most abundant element in the universe and is contained in large amounts in many chemical compounds.

The most readily available chemical feedstock for hydrogen is organic compounds, primarily hydrocarbons and oxygenated hydrocarbons. Several proven technologies such as steam reforming, auto-thermal reforming, partial oxidation, water gas shift and water splitting using various catalysts have been applied to extract hydrogen from fuels like gasoline, diesel, LPG, methane, ethanol and methanol.

For mobile applications, methanol has been identified as a suitable (transportable) fuel that can easily be processed—on board—to form hydrogen-rich gas for a solid polymer fuel cell (SPFC). This is considered to be a candidate for transport applications. Catalytic steam reforming of methane is another source for large scale hydrogen production. In this process, hydrogen production is accomplished in several steps: steam reforming, water gas shift reaction, and hydrogen purification. The steam reforming reaction is endothermic and requires external heat input. The reactor operates at pressures of 3-25 atmospheres and temperatures above 800° C.

Present methanol reformers are usually fixed-bed catalytic reactors that suffer from a number of inherent problems. They operate at high temperature (>300° C.) and require special catalysts. Hot and cold spots are commonly encountered in the catalyst bed that results in poor performance over longer periods of time. These types of reactors typically have poor response to transients. Similarly they require a prolonged time to reach working temperature from cold start-up and then decay fast due to inherent technical problems.

Although the prior art steam reforming processes effectively generate hydrogen from methanol, they suffer from several drawbacks. First, the reactions are endothermic at room temperature and therefore require heating. Temperatures of several hundred degrees are needed to achieve high reaction rates. These temperatures are costly to provide, impose special requirements on the materials used to construct the reactors, and limit the range of applications. Second, the required high temperatures imply that steam reform reactions occur in the gas phase. This means that hydrogen must be recovered from a mixture of gases through some means of separation. This adds cost and complexity to the reformation process and makes it difficult to obtain perfectly pure hydrogen. Finally, the production of CO₂ and/or CO is environmentally undesirable since both gases contribute to the greenhouse effect believed to be responsible for global warming.

A more recent development for the production of hydrogen at a reaction temperature of about 15° to 80° C. is disclosed in the U.S. patent of Park et al. U.S. Pat. No. 5,865,960. As disclosed therein hydrogen is produced from water with a photocatalyst in combination with a promoter. The photocatalyst consists of a catalytically active ingredient, cesium (Cs) impregnated in support K₄Nb₅O₁₇ represented by the formula Cₛ(a)K₄Nb₆O₁₇ wherein (a) denotes the amount of catalytically active ingredient Cs. The patent also discloses illumination of an aqueous solution containing an oxygen containing promoter with ultraviolet light.

A more recent patent of Park et al. U.S. Pat. No. 6,017,425 also discloses a process for the photocatalytic production of hydrogen at low temperatures without using any organic promoter. As disclosed therein, a ZnS carrier comprsing ZnS (molar ratio Zn:S=1:0.1-2:8 alone or in combination with an inorganic component selected from the group consisting of silica, alumina, niobate, titania and zirconia as a powerful ability to generate hydrogen when in contact with primary or secondary distilled water or simply pretreated water at 10 to 85° C.+.

A U.S. Patent Application Publication of Futamura et al. No. 2003/0175,084 discloses a process for production of hydrogen from hydrocarbons, alcohols (methanol) and water using non-thermal plasma. The term “non-thermal plasma” refers to a plasma wherein electronic ions and neutral molecules are not in thermal equilibrium. As disclosed in this publication, a gas temperature can be suppressed to approximately room temperature although electron temperatures reach 8,000 to 40,000° C.

It now appears that there is a need for producing hydrogen from organic chemical feedstock in an efficient, economically feasible, and environmentally friendly way. It is also desirable to have a process for producing hydrogen that is more effective at room temperature than the current commonly used processes and that avoids or minimizes the production of environmentally harmful gases as by-products. Discovery of a novel process for producing hydrogen like laser based photocatalytic conversion of methanol will greatly advance the cause of achieving a clean-burning economical fuel based on hydrogen.

The process in accordance with the present invention is a non-aqueous process, eliminates a need for a difficult to prepare catalyst such as K₄Nb₆O₁₇ and avoids formation of an explsive oxygen containing mixture. It is also more efficient then the process of the aforementioned U.S. Pat. No. 5,865,960. In addition, it is presently believed that by changing the laser radiation frequency, it may be possible to control the reaction process and yields from methanol, ethanol and other oxygenated hydrocarbons.

### BRIEF SUMMARY OF THE INVENTION

In essence, the present invention contemplates a method for the photocatalytic conversion of an oxygenated hydrocarbon into hydrogen with lesser amounts of carbon monoxide and/or carbon dioxide. The method includes the step of forming a suspension of a semiconductor catalyst such as a metal oxide in powder form in a liquid oxygenated hydrocarbon, preferably methanol. In a second step, the suspension is irradiated with laser radiation in the range of 180 nm to 520 nm at a temperature of less than 70° C. and preferably at room temperature to thereby generate a high yield of hydrogen.

In a preferred embodiment of the invention, the metal oxide catalyst is selected from the group consisting of NiO, Fe₂O₃, ZnO, WO₃ and TiO₂ is mixed with methanol in an amount of between about 100 mg to 500 mg of catalyst per 50 mL of methanol to form a colloidal suspension which is irradiated with a third harmonic of an Nd: YAG laser for a period of at least about 30 minutes at room temperature.

The invention also contemplates an apparatus for the production of hydrogen from an oxygenated hydrocarbon using a laser photocatalytic process. The apparatus includes a closed cell having an outer shell and an inner cavity with a window of optical grade quartz. The closed cell is adapted to receive a mass of a oxygenated hydrocarbon such as methanol and a mass of a metal oxide catalyst therein and includes a magnetic stir within the inner cavity. Means for rotating the magnetic stirrer are disposed outside of the outer shell and preferably adjacent to the bottom of the cell for forming a colloidal suspension of the metal oxide within the oxygenated hydrocarbon. A laser, preferably a Nd: YAG laser and optically aligned means for directing light from the laser through the window to thereby irradiate the colloidal suspension and produce hydrogen is provided. The apparatus also includes a liquid inlet and gas outlet. In a preferred embodiment, the apparatus also includes a gas sampling valve and liquid sampling valve and a laser meter.

In the present work, a novel process for the efficient production of hydrogen gas from oxygenated hydrocarbons such as methanol were developed. The process is based on the photocatalytic conversion of oxygenated hydrocarbon in the presence of a semiconductor catalyst using a UV laser as a light source. A laser beam of 355 nm wavelength and a specially designed reaction cell were employed. The major reaction product i.e. molecular hydrogen (H₂) and other gases such as CH₄ and CO, in nominal concentrations, were analyzed by using a calibrated gas chromatograph using a selective wide bore capillary column capable of separating all the components of an evolved gaseous mixture. Various photocatalysts were studied for the conversion of methanol to hydrogen. These include, but are not limited to, WO₃, NiO, Fe₂O₃, TiO₂ and ZnO. In a particularly preferred embodiment of the present invention, hydrogen gas is produced from the reaction of methanol in the presence of a photocatalyst under laser irradiation at room temperature.

The following set of equations outline the pathways for the production of hydrogen and other gases in this method:
Semiconduc tor Catalyst (SC)+hυ→SC(h_{vb}⁺,e_{cb}⁻)
CH₃OH+h_{vb}⁺→CH₃O⁺H
CH₃O⁺H→CH₂O+H⁺+H.
H⁺+e_{cb}⁻→H.
H.+H.→H₂
CH₂O+h_{vb}⁺→CO+H⁺+H.
CH₃OH+H.→CH₄+OH.

The invention will now be described in connection with the accompanying Figures.

### BRIEF DESCRIPTION OF THE DRAWINGS

FIG. 1 is a diagrammatic illustration of an apparatus according to a first embodiment of the invention;

FIG. 2 is the plot of the yield of hydrogen gas (mole %) produced as a function of amount of catalyst (mg) in the reaction of a mixture containing 50 cm³ of methanol and various concentrations of WO₃ catalyst at ambient temperature (22° C.) under illumination of 150 mJ per pulse laser radiation at a wavelength of 355 nm for a duration of 30 minutes;

FIG. 3 is a graph which illustrates the yield of hydrogen gas (mole %) produced as a function of time (minutes) in the reaction of a mixture containing 50 cm³ of methanol and 500 mg of Fe₂O₃ catalyst at ambient temperature (22° C.) under illumination of 150 mJ per pulse laser radiation at a wavelength of 355 nm;

FIG. 4 is a graph which illustrates the yield of hydrogen gas (mole %) produced as a function of time (minutes) in the reaction of a mixture containing 50 cm³ of methanol and 500 mg of TiO₂ catalyst at ambient temperature (22° C.) under illumination of 150 mJ per pulse laser radiation at a wavelength of 355 nm;

FIG. 5 is a graph which illustrates the yield of hydrogen gas (mole %) produced as a function of time (minutes) in the reaction of a mixture containing 50 cm³ of methanol and 500 mg of ZnO catalyst at ambient temperature (22° C.) under illumination of 150 mJ per pulse laser radiation at a wavelength of 355 nm;

FIG. 6 is a graph which illustrates the yield of hydrogen gas (mole %) produced as a function of time (minutes) in the reaction of a mixture containing 50 cm³ of methanol and 500 mg of WO₃ catalyst at ambient temperature (22° C.) under illumination of 150 mJ per pulse laser radiation at a wavelength of 355 nm; and

FIG. 7 is a graph which illustrates the yield of hydrogen gas (mole %) produced as a function of time (minutes) in the reaction of a mixture containing 50 cm³ of methanol and 500 mg of NiO catalyst at ambient temperature (22° C.) under illumination of 150 mJ per pulse laser radiation at a wavelength of 355 nm.

### DESCRIPTION OF THE PREFERRED EMBODIMENTS OF THE INVENTION

The present invention relates to the photocatalytic conversion of oxygenated organic compounds such as methanol to produce hydrogen (H₂) under laser irradiation without producing oxygen.

The term “hydrocarbon” as defined herein refers to chemical compounds comprising carbon and hydrogen and includes alkanes, alkenes, alkynes and substituted forms thereof. The term “oxygenated hydrocarbon” as defined herein refers to organic compounds comprising carbon, hydrogen, and oxygen and includes alcohols, aldehydes, ketones, ethers, carboxylic acids and substituted forms thereof. The term photocatalysis as defined herein refers to photon-assisted reactions in the presence of a semiconductor. The term photocatalyst or catalyst defined herein refers to semiconductors powders, which includes WO₃, NiO, Fe₂O₃, TiO₂ and ZnO.

A photocatalytic process for production of hydrogen is based upon the illumination of a colloidal suspension i.e. a mixture of a liquid organic compound and a semiconductor powder with energy equal to or greater than the band gap of the semiconductor. The interaction of a laser photon (hν) with the semiconductor excites an electron from the valence band to the conduction band leaving a positive electronic vacancy called (h_{vb}⁺). This excitation of electron to the conduction band creates oxidation and reduction sites at the surface of the semiconductor particle. These redox sites are capable of reducing and oxidizing the adsorbed solvent molecules i.e. methanol. The donation of electrons by the oxygenated organic compound to the photo-generated holes causes the oxidation of the compound, which rearrange to give protons (hydrogen ions), hydrogen radicals and another oxygen bearing intermediate.

The produced hydrogen ions capture the conduction band electron to give hydrogen radicals which combines with each other to give hydrogen gas. The detailed mechanism is presented above. These pathways generate hydrogen without the formation of the environmentally undesirable gases carbon monoxide and/or carbon dioxide in appreciable amounts contrary to what occurs in the conventional hydrogen production through a steam reform processes. The presently disclosed procedure is based upon photocatalysis using an intense laser light source which permits the reaction in the liquid phase at room temperature and avoids the high temperatures or steam conditions typical of prior art hydrogen production processes. Furthermore, in the present invention, hydrogen is the major gas product with minor amounts of other gases such as CO and CH₄. Consequently, the hydrogen gas produced by the present invention is easily recoverable and deliverable to a hydrogen-based energy or storage device such as a fuel cell or hydrogen storage alloy.

A wide variety of hydrocarbon and oxygenated hydrocarbon compounds are suitable for the present invention including, but not limited to, alcohols, aldehydes, ketones, ethers etc. Suitable photocatalysts that can be used to initiate the reaction include, but are not limited to, WO₃, NiO, Fe₂O₃, TiO₂ and ZnO. In a particularly preferred embodiment of the present invention, hydrogen gas is produced from the reaction of methanol with the presence of a metal oxide semiconductor under laser irradiation. Experiments were also conducted and hydrogen produced from ethanol and propanol.

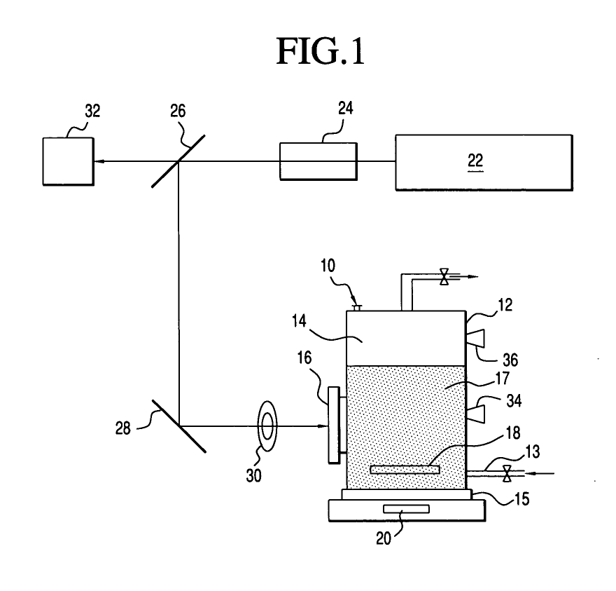

As illustrated in FIG. 1, an apparatus for the production of hydrogen from an oxygenated hydrocarbon includes a Pyrex (borosilicate glass) generally cylindrical closed cell 10 of about 35 mm diameter and about 120 mm height. The cell 10 which was used to conduct experiments as disclosed herein, also includes an optical grade quartz window 16 for transmission of a UV and visible light beam. The closed cell 10 is adapted to receive a mass of an oxygenated hydrocarbon such as methanol, ethanol or propanol (a liquid) and a mass of a metal oxide catalyst in powder form. The methanol and powder catalyst may be injected into a lower portion 17 of the cell 10 through an inlet or injection port 13.

The cell also includes a magnetic stirrer 18 in lower portion 17 for forming and/or maintaining a colloidal suspension of the metal oxide catalyst in the methanol. Means 20 for rotating the magnetic stir 18 is disposed in a lower base 19 which is below and abutting a base 15 of the cell 10. The cell 10 also includes a gas outlet 21 in an upper portion 14 of the cell 10. For experimental purposes a liquid sampling valve 34 or rubber septum and gas sampling valve or rubber septum 36 are provided in the lower and upper portions 17 and 14 respectively.

A laser 22 such as an Nd:YAG laser for generating a light at a wavelength of about 1060 nm and means 24 for generating a third harmonic of 355 nm of light are optically aligned for directing a beam of light through the window 16 and into the lower portion 17 of the cell 10 for irradiating the metal oxide suspension contained therein. As illustrated, the 355 nm light beam is directed through the window 16 by means of an inclined beam splitter 26 and inclined mirror 28 with a beam diameter controller 30 disposed between the mirror 28 and window 16. For experimental purposes, a laser energy meter 32 is optically aligned with the beam 22 but separated therefrom by the beam splitter 26 and means 24.

Several experiments were conducted to demonstrate the photocatalytic conversion process for the production of hydrogen from oxygenated hydrocarbon compounds. Keeping in view the importance of the experimental parameters and their effect on hydrogen yield, the first step was to optimize the amount of photocatalyst and laser energy for maximum production of hydrogen. The above-mentioned parameters were optimized for WO₃ and kept constant for other catalysts for the sake of comparison. The range studied for the optimization of the amount of catalyst was 50-2000 mg while for optimization of laser energy, the range studied was 20-300 mJ.

To study the photocatalytic conversion of methanol, the optimized amount of photocatalyst was suspended in an appropriate quantity of methanol. The suspension was then irradiated with the optimized laser energy. All the experiments were performed in an argon environment. The evolved gases were analyzed by removing 100 μl of gas sample from the dead volume of the photocatalytic reactor using a gas tight syringe at regular time intervals. The sample was then injected in a gas chromatograph (Shimadzu, Model GC-17) equipped with 30 meter molecular sieve 5A plot column and a TCD detector.

The light source, a 355 nm wavelength laser beam, was generated from the third harmonic of a Spectra Physics Nd:YAG laser (Model GCR 250). The pulse width of the laser was ˜8 nsec with a 10 Hz repetition rate. The laser beam was directed into the center of the reaction chamber using a set of mirrors. For all the measurements, the laser beam diameter was kept constant at 8 mm. This precaution was taken to ensure the exposure of the same volume of the catalyst and to study the parametric dependence under the same photon intensity. Specific experiments were performed to study the photocatalytic production of hydrogen are described below.

### EXAMPLE 1

Effect of Laser Power on Hydrogen Production

This example illustrates the effect of incident laser power on hydrogen production for the photocatalytic conversion of methanol into hydrogen. In this experiment, methanol and a photocatalyst were mixed in the reaction cell. Specifically, 50 mL of methanol and 500 mg of WO₃ catalyst were placed in the reaction cell. No evolution of gas was observed from the mixture of methanol and catalyst without laser irradiation. The absence of gas evolution indicates that the reformation of methanol does not occur and that hydrogen gas is produced only under illumination. The excitation source, a 355 nm wavelength high power laser beam was generated from the third harmonic of the Spectra Physics Nd:YAG laser (Model GCR 250). The laser energy per pulse was varied from 50 mJ to 300 mJ. The reaction products were characterized using a gas chromatographic system equipped with a wide bore capillary column and TCD detector. The products include hydrogen and methane. As discussed in the prior art, temperatures well above the boiling point are required to observe appreciable hydrogen formation from a mixture of methanol and water in steam reformation. The present invention does not require extreme experimental conditions and the process works well at room temperature. The hydrogen yield at different laser energies for WO₃ and NiO catalysts are presented in table 1. The yield of hydrogen presented in table 1 was recorded for irradiation of the mixture with 355 nm laser beam for a duration of 30 minutes.

### EXAMPLE 2

Effect of Catalyst Concentration on Hydrogen Yield

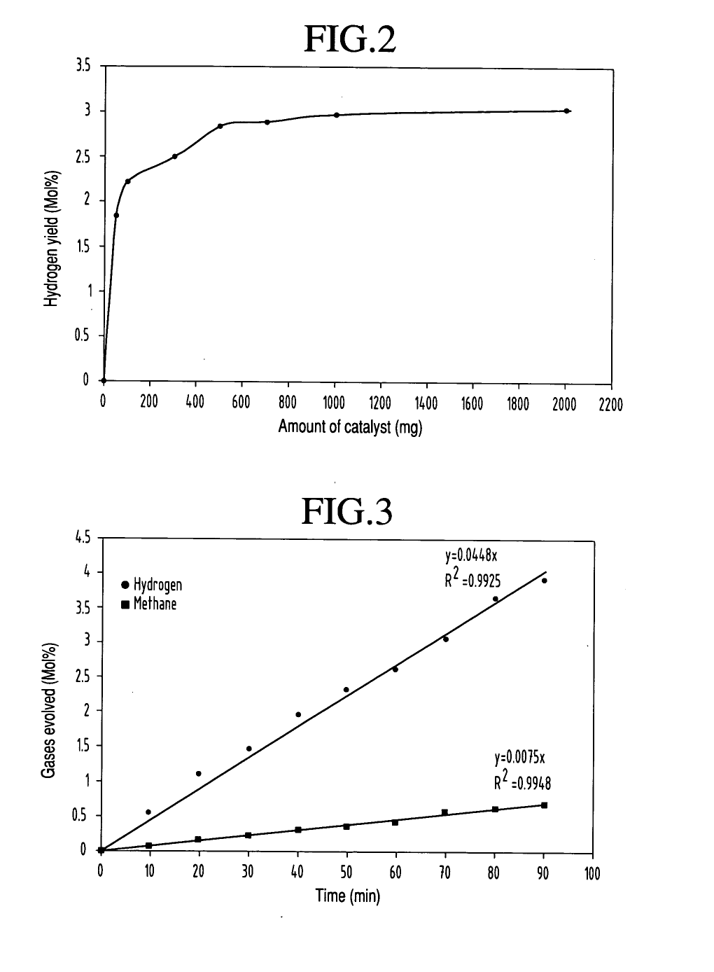

This example illustrates the relationship of hydrogen yield and catalyst concentration for photocatalytic conversion of methanol into hydrogen. In this experiment, methanol and WO₃ photocatalyst were mixed in the reaction cell. The dependence of yield on catalyst concentration was studied by keeping all the other parameters such as laser energy and laser exposure time constant. In this case, hydrogen yield for various concentrations of WO₃ catalyst were measured by using the same procedure mentioned above. Here the concentration of WO₃ was varied from 50 mg to 2000 mg and the yield shows strong dependence on the concentration of catalyst from 50 to 500 mg. Here the laser energy was for higher concentrations the yield is not as dependent on catalyst concentration. No evolution of any product gas was observed from the mixture of methanol and catalyst without laser irradiation. The absence of gas evolution indicates that the photocatalytic production of hydrogen gas occurs under illumination only. The excitation source, 355 nm wavelength high power laser beam was generated from the third harmonic of the Spectra Physics Nd: YAG laser (Model GCR 250). The reaction products were characterized using a gas chromatographic system equipped with a wide bore capillary column. The products include hydrogen and methane. As discussed in the prior art, temperatures well above the boiling point are required to observe appreciable hydrogen formation from a mixture of methanol and water due to steam reformation. However, the present invention does not require extreme experimental conditions and the process works well at room temperature. A typical plot of WO₃ concentration dependence of hydrogen and methane yield is presented in FIG. 2. The hydrogen yield at different concentration of WO₃ and NiO catalysts is presented in table 2. The yield of hydrogen presented in table 1 was recorded for irradiation of the mixture with 355 nm laser beam for a duration of about 30 minutes.

### EXAMPLE 3

Evolution of Hydrogen Production with Exposure Time Over Fe₂O₃ Catalyst

This example illustrates how the hydrogen production yield varies with time during the photocatalytic conversion of methanol into hydrogen using Fe₂O₃ as a catalyst. In this experiment, methanol and Fe₂O₃ photocatalyst were mixed in the reaction cell. The dependence of production yield on laser exposure was studied by keeping all the other parameters such as laser energy and Fe₂O₃ catalyst concentration as constant. In this case, hydrogen yield at regular time intervals using Fe₂O₃ catalyst was measured. Here the concentration of Fe₂O₃ was 500 mg while laser energy was 150 mJ per pulse. A typical plot of hydrogen yield (mole %) and methane (mole %) versus the laser exposure time is presented in FIG. 3. A maximum hydrogen yield of 4.3 mole % was achieved within 90 minutes which is quite substantial compared to other techniques at room temperature using a small volume of methanol.

The excitation source, 355 nm wavelength high power laser beam was generated from the third harmonic of the Spectra Physics Nd: YAG laser (Model GCR 250). The reaction products were characterized using a gas chromatographic system equipped with a wide bore capillary column. The products include hydrogen and methane. As discussed in the prior art, temperatures well above the boiling point are required to observe appreciable hydrogen formation from a mixture of methanol and water due to steam reformation. Our invention does not require extreme experimental conditions and the process worked well at room temperature.

### EXAMPLE 4

Evolution of Hydrogen Production with Exposure Time Over TiO₂ Catalyst

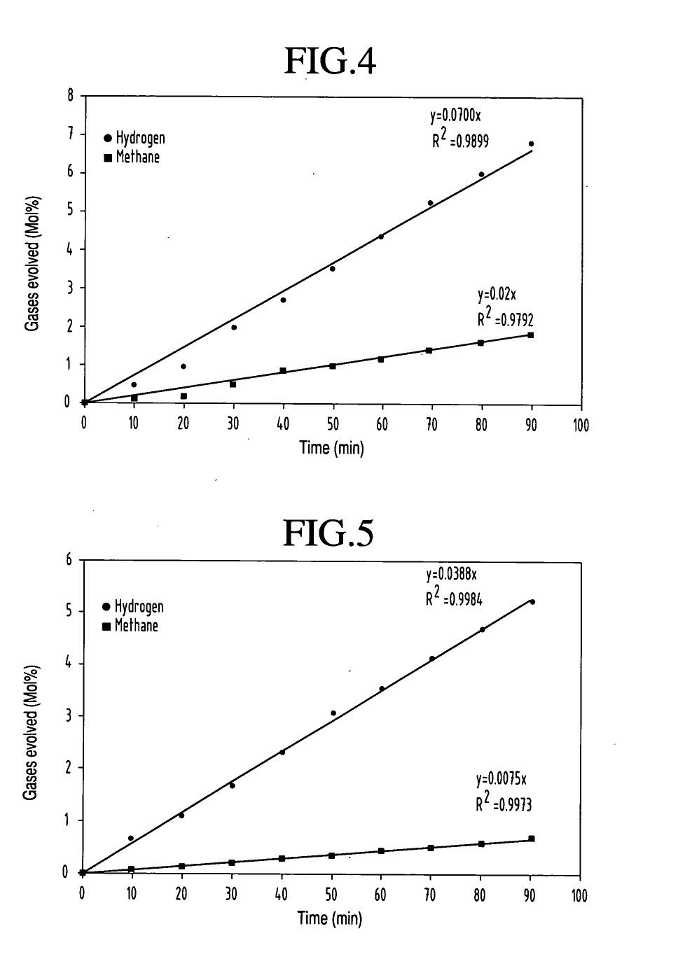

This example illustrates how the hydrogen production yield varies with time during the photocatalytic conversion of methanol into hydrogen using TiO₂ as a catalyst. In this experiment, methanol and TiO₂ photocatalyst were mixed in the reaction cell. The dependence of production yield on laser exposure was studied by keeping all the other parameters such as laser energy and TiO₂ catalyst concentration constant. In this case, hydrogen yield at regular time intervals using TiO₂ catalyst was measured. Here the concentration of TiO₂ was 500 mg while laser energy was 150 mJ per pulse. A typical plot of hydrogen yield (mole %) and methane (mole %) versus the laser exposure time is presented in FIG. 4. A maximum hydrogen yield of 7 mole % was achieved within 90 minutes which is substantial at room temperature.

The excitation source, 355 nm wavelength high power laser beam was generated from the third harmonic of the Spectra Physics Nd: YAG laser (Model GCR 250). The reaction products were characterized using a gas chromatographic system equipped with a capillary column. The products include hydrogen and methane. As discussed in the prior art, temperatures well above the boiling point are required to observe appreciable hydrogen formation from a mixture of methanol and water due to steam reformation. However, the present process does not require extreme experimental conditions and works well at room temperature.

### EXAMPLE 5

Evolution of Hydrogen Production with Exposure Time Over ZnO Catalyst

This example illustrates how the hydrogen production yield varies with time during the photocatalytic conversion of methanol into hydrogen using ZnO as catalyst. In this experiment, methanol and ZnO photocatalyst were mixed in the reaction cell. The dependence of production yield on laser exposure was studied by keeping all the other parameters, such as laser energy and ZnO catalyst concentration, as constant. In this case, hydrogen yield at regular time intervals using a ZnO catalyst was measured. Here the concentration of ZnO was 500 mg while laser energy was 150 mJ per pulse. A typical plot of hydrogen yield (mole %) and methane (mole %) versus the laser exposure time is presented in FIG. 5. A maximum hydrogen yield of 5.5 mole % was achieved within 90 minutes at room temperature.

The excitation source, 355 nm wavelength high power laser beam was generated from the third harmonic of the Spectra Physics Nd: YAG laser (Model GCR 250). The reaction products were characterized using a gas chromatographic system equipped with a wide bore capillary column. The products include hydrogen and methane. As discussed in the prior art, temperatures well above the boiling point are required to observe appreciable hydrogen formation from a mixture of methanol and water due to steam reformation. The process disclosed herein does not require extreme experimental conditions and the process works well at room temperature.

### EXAMPLE 6

Evolution of Hydrogen Production with Exposure Time Over WO₃ Catalyst

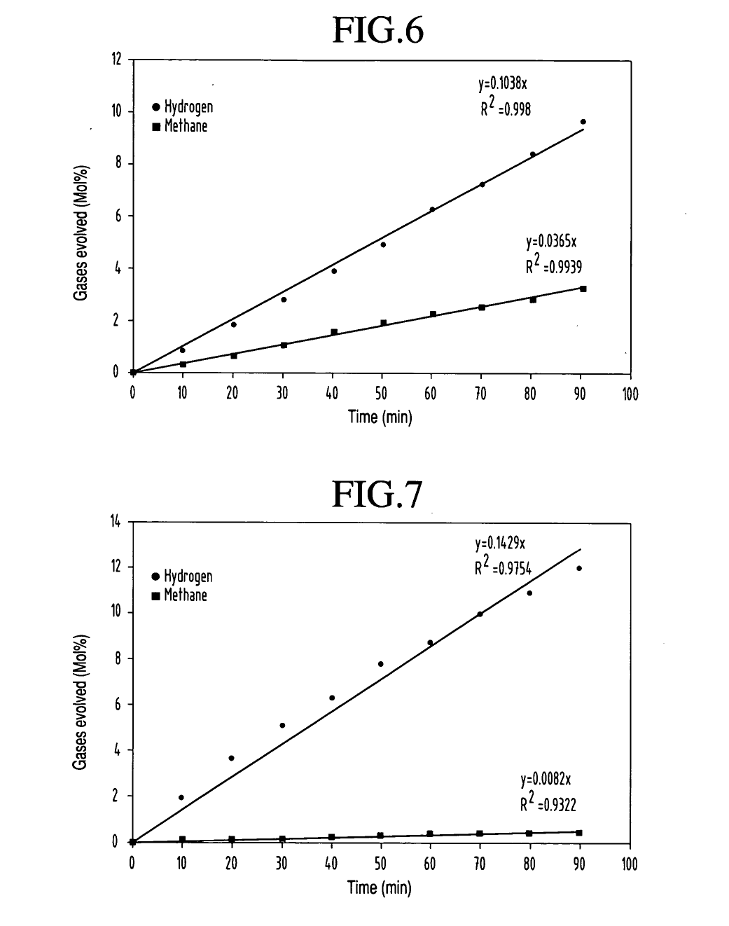

This example illustrates how the hydrogen production yield varies with time during the photocatalytic conversion of methanol into hydrogen using WO₃ as a catalyst. In this experiment, methanol and WO₃ photocatalyst were mixed in the reaction cell. The dependence of production yield on laser exposure was studied by keeping all the other parameters, such as laser energy and WO₃ catalyst concentration, as constant. In this case, hydrogen yield at regular time intervals using WO₃ catalyst was measured. Here the concentration of WO₃ was 500 mg while laser energy was 150 mJ per pulse. A typical plot of hydrogen yield (mole %) and methane (mole %) versus the laser exposure time is presented in FIG. 6. A maximum hydrogen yield of 12 mole % was achieved within 90 minutes at room temperature.

The excitation source, 355 nm wavelength high power laser beam was generated from the third harmonic of the Spectra Physics Nd: YAG laser (Model GCR 250). The reaction products were characterized using a gas chromatographic system equipped with a wide bore capillary column. The products include hydrogen and methane. As discussed in the prior art, temperatures well above the boiling point are required to observe appreciable hydrogen formation from a mixture of methanol and water due to steam reformation. The present invention does not require extreme experimental conditions and the process works well at room temperature.

### EXAMPLE 7

Dependence of Hydrogen Production on Laser Exposure Time Using NiO Catalyst

This example illustrates how the hydrogen production yield varies with time during the photocatalytic conversion of methanol into hydrogen using NiO as a catalyst. In this experiment, methanol and NiO photocatalyst were mixed in the reaction cell. The dependence of production yield on laser exposure was studied by keeping all the other parameters, such as laser energy and NiO catalyst concentration, as constant. In this case, the hydrogen yield at regular time intervals using NiO catalyst was measured. Here the concentration of NiO was 500 mg while laser energy was 150 mJ per pulse. A typical plot of hydrogen and methane yields mole %) versus the laser exposure time is presented in FIG. 7. A maximum hydrogen yield of 13 mole % was achieved within 90 minutes at room temperature.

The excitation source, 355 nm wavelength high power laser beam was generated from the third harmonic of the Spectra Physics Nd: YAG laser (Model GCR 250). The reaction products were characterized using a gas chromatographic system equipped with a wide bore capillary column.

Experiments with ethanol and propanol were also conducted and conversion into hydrogen, methane and CO were detected. However, the concentrations were not as high as with methanol.

TABLE 1
Hydrogen yield recorded at various concentrations of WO₃ and NiO
catalysts using 355 nm wavelength laser exposure for 30 minutes duration.

| | WO₃ | NiO |
|---|---|---|
| Amount of catalyst | Hydrogen yield | Hydrogen yield |
| (mg) | (Mol %) | (Mol %) |
| 50 | 1.85 | 1.62 |
| 100 | 2.23 | 2.14 |
| 300 | 2.50 | 3.42 |
| 500 | 2.85 | 4.53 |
| 700 | 2.90 | 4.99 |
| 1000 | 2.99 | 5.37 |
| 2000 | 3.06 | 5.52 |

TABLE 2
Comparison of hydrogen yield measured at different laser energies for
WO₃ and NiO catalysts.

| | WO₃ | NiO |
|---|---|---|
| | Hydrogen Yield | Hydrogen Yield |
| Laser Energy (mJ) | (Mol %) | (Mol %) |
| 50 | 0.198 | 0.912 |
| 100 | 0.902 | 3.258 |
| 150 | 2.376 | 6.605 |
| 200 | 5.278 | 10.233 |
| 300 | 11.739 | 16.528 |

While the invention has been described in connection with its preferred embodiments, it should be recognized that changes and modifications can be made therein without departing from the scope of the appended claims.

1. A method for the photocatalytic conversion of an oxygenated hydrocarbon into hydrogen comprising the steps of:
forming a suspension of an oxygenated hydrocarbon and a metal oxide semiconductor catalyst; and
irradiating the suspension with laser radiation in the range of 180 nm to 520 nm at a temperature of less than 70° C. to thereby generate a high yield of hydrogen.

2. A method for the photocatalytic conversion of an oxygenated hydrocarbon according to claim 1 which includes the step of providing a semiconductor catalyst selected from the group consisting of nickel oxide (NiO), iron oxide (Fe₂O₃), zinc oxide (ZnO), tungsten oxide (WO₃) and titanium oxide (TiO₂).

3. A method for the photocatalytic conversion of an oxygenated hydrocarbon into hydrogen according to claim 2 in which the suspension is maintained at about 22° C.

4. A method for the photocatalytic conversion of an oxygenated hydrocarbon into hydrogen according to claim 3 in which the suspension is irradiated for a period of about 30 minutes.

5. A method for the photocatalytic conversion of methanol into hydrogen comprising the steps of:
providing a mass of methanol and a semiconductor catalyst;
forming a suspension of methanol and semiconductor catalyst; and
irradiating the suspension with laser radiation in the range of 180 nm to about 520 nm at a temperature at between about 10° C. and about 70° C. to generate a high yield of hydrogen.

6. A method of photocatalytic conversion of methanol into hydrogen according to claim 5 in which the suspension is irradiated with light having a wavelength of 355 nm at room temperature.

7. A method of photocatalytic conversion of methanol into hydrogen according to claim 5 in which the suspension is heated to about 60° C.

8. A method of photocatalytic conversion of methanol into hydrogen according to claim 5 in which the semiconductor catalyst is selected from the group consisting of nickel oxide (NiO), iron oxide (Fe₂O₃), zinc oxide (ZnO), tungsten oxide (WO₃) and titanium oxide (TiO₂).

9. A method of photocatalytic conversion of methanol into hydrogen according to claim 8 in which the suspension is irradiated with illumination of about 150 mJ per pulse laser radiation at a wavelength of about 355 nm.

10. A method of photocatalytic conversion of methanol into hydrogen according to claim 9 in which the suspension is irradiated for a period of at least about 30 minutes.

11. A method of photocatalytic conversion of methanol into hydrogen according to claim 8 in which the suspension contains at least about 100 mg of metal oxide catalyst per 50 cm³ of methanol.

12. A method for the photocatalytic conversion of methanol into hydrogen according to claim 11 in which the suspension contains about 500 mg of WO₃ per 50 mL of methanol and is irradiated with a high power laser beam of 355 nm wavelength generated from a third harmonic of an Nd:YAG laser with an energy per pulse of between about 50 to 300 mJ at about 22° C.

13. A method for the photocatalytic conversion of methanol into hydrogen according to claim 11 in which the suspension contains about 500 mg of NiO₂ per 50 mL of methanol and is irradiated with a high power laser beam of 355 nm wavelength from a third harmonic of an Nd:YAG laser with an energy per pulse of about 150 mJ at room temperature.

14. A method of photocatalytic conversion of methanol into hydrogen according to claim 14 in which the suspension contains about 500 mg of Fe₂O₃ per 50 mL of methanol and is irradiated with a high power laser beam of 355 nm wavelength generated from a third harmonic of an Nd:YG laser with an energy per pulse of about 150 mJ at room temperature.

15. A method of photocatalytic conversion of methanol into hydrogen according to claim 11 in which the suspension contains about 500 mg TiO₂ per 50 mL of methanol and is irradiated with a high power laser beam of 355 nm wavelength generated from a third harmonic of an Nd:YAG laser with an energy per pulse of about 150 mJ at room temperature.

16. A method of photocatalytic conversion of methanol into hydrogen according to claim 11 in which the suspension contains about 500 mg ZnO per 50 mL of methanol and is irradiated with a high power laser beam of 355 nm wavelength generated from a third harmonic of an Nd:YAG laser with an energy per pulse of about 150 mJ at room temperature.

17. Apparatus for the production of hydrogen from an oxygenated hydrocarbon using a laser photocatalytic process, the apparatus comprising:
a closed cell including an inner and an outer portion with a window therein for receiving a mass of an oxygenated hydrocarbon liquid and a metal oxide semiconductor catalyst in powder form, a magnetic stirrer disposed in said inner portion and means for activating said magnetic stirrer disposed outside of said cell to form a colloidal suspension of the semiconductor powder in the liquid oxygenated hydrocarbon, a laser and optically aligned means for directing light from said laser through said window to thereby generate hydrogen and means for removing hydrogen from said cell.

18. Apparatus for the production of hydrogen from an oxygenated hydrocarbon according to claim 17 in which said optically aligned means for directing light from said laser through said window includes a third harmonic generator for providing light at 355 nm.

19. Apparatus for the production of hydrogen from an oxygenated hydrocarbon according to claim 18 which includes a beam diameter controller.

20. Apparatus for the production of hydrogen from an oxygenated hydrocarbon according to claim 18 which includes a beam splitter and a mirror for directing the laser energy through said window and into said cell and an energy meter disposed behind said beam splitter.

21. Apparatus for the production of hydrogen from an oxygenated hydrocarbon according to claim 18 in which said cell includes an inlet valve, a liquid sampling valve and a gas sampling valve.

22. Apparatus for the production of hydrogen from an oxygenated hydrocarbon according to claim 18 in which said radiation from said laser is produced with a laser energy of between about 50 to 300 mJ per pulse.

23. A method for the photocatalytic conversion of an oxygenated hydrocarbon according to claim 3 which includes the step of providing a methanol, ethanol or propanol.

24. A method for the photcatalytic conversion of an oxygenated hydrocarbon according to claim 23 which includes the step of controlling the laser radiation frequency to control the reaction process and yields from methanol, ethanol and other oxygenated hydrocarbons.
